(19) United States
(12) Patent Application Publication
(10) Pub. No.: US 2026/0217575 A1
(43) Pub. Date: Jul. 30, 2026

(54) ELECTROCHEMICAL DEGRADATION OF FLUORINATED ORGANIC COMPOUNDS IN AQUEOUS SOLUTIONS

(71) Applicant: Yeda Research and Development Co. Ltd., Rehovot (IL)

(72) Inventors: Brian BERKOWITZ, Rehovot (IL); Phillip VERSHININ, Rehovot (IL); Ishai DROR, Rehovot (IL); Omri SEEMANN, Rehovot (IL)

(21) Appl. No.: 19/158,218

(22) PCT Filed: Feb. 20, 2024
(86) PCT No.: PCT/IL2024/050193

§ 371 Date: Aug. 20, 2025

(30) Foreign Application Priority Data
Feb. 22, 2023 (IL) 300872

(51) Int. Cl. C02F 1/467; C02F 1/461; C02F 101/34; C02F 101/36; C02F 101/38

(52) U.S. Cl. CPC C02F 1/4674; C02F 1/46109; C02F 2001/46142; C02F 2001/46152; C02F 2101/34; C02F 2101/36; C02F 2101/38; C02F 2101/40

(57) ABSTRACT

An electrochemical decontamination method of removing fluorinated organic compound(s) (FOC(s)) from an aqueous stream, comprising applying electric voltage across electrodes in contact with the FOC(s)-containing aqueous stream in the presence of at least one Mⁿ⁺ and at least one A^{k-}, wherein Mⁿ⁺ is a reducible cation of a transition metal that can assume multiple oxidation states and A^{k-} is an oxidizable anion.

### CROSS-REFERENCE TO RELATED APPLICATIONS

This application is a National Stage application of International Patent Application No. PCT/IL2024/050193 filed on Feb. 20, 2024, which claims priority to Israeli Patent Application 300872, filed Feb. 22, 2023, each of which is hereby incorporated by reference in its entirety.

### BACKGROUND

Fluorinated organic compounds (FOCs) contain one or more carbon-fluorine (C—F) bond(s). FOCs are fundamental components in different aspects of our daily lives. FOCs can be found in coatings, such as Teflon coating, food wrappers, raincoats, in fire extinguishing foams, pesticides and many more. They are also ubiquitous in pharmaceutically active substances like 5-fluorouracil (5FU)-used for cancer treatment or antibiotics. All these products are eventually consumed and thrown away, which introduces the FOCs to the environment. A class of FOCs worth mentioning consists of perfluorinated surfactants (PFSs), e.g., perfluorooctanoic acid (PFOA) and perfluorooctanoic sulfate (PFOS).

The chemical structures of the three FOCS mentioned above are depicted below:

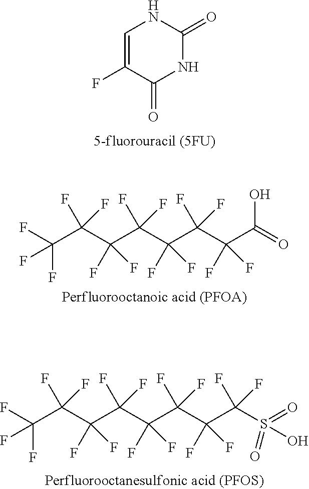 [SMILES: O=c1[nH]cc(F)c(=O)[nH]1 ; O=C(O)C(F)(F)C(F)(F)C(F)(F)C(F)(F)C(F)(F)C(F)(F)C(F)(F)F ; O=S(=O)(O)C(F)(F)C(F)(F)C(F)(F)C(F)(F)C(F)(F)C(F)(F)C(F)(F)C(F)(F)F]

FOCs are particularly challenging contaminants to degrade. The C—F bond is rather strong; the C—F bond remains unchanged, even if the compounds degraded partly. As fluorine is the most electronegative element, it cannot be oxidized to fluorine gas (F₂). The C—F can only be reduced; to this end a strong reducer is necessary.

One approach to FOCs removal from polluted water is based on electrochemical degradation, i.e., application of a voltage across electrodes immersed in the water. A review entitled “Electrochemical oxidation of perfluorinated compounds in water” [J. Niu, Y. Li, E. Shang, Z. Xu, J. Liu, Chemosphere. 146 (2016) 526-538] indicates that electrodes made of boron-doped diamond, tin oxide, and lead dioxide, are effective in PFCs elimination in wastewater due to their high oxygen evolution potential. Although degradation of the organic part of the FOCs can be done by the action of anodically generated reactive oxygen species (ROS), the cleavage of the C—F bond to produce fluoride cannot be easily achieved. For example, electrochemical degradation of o-fluoroaniline was reported with slow (2 days) and low fluoride production (8.8%) [H. Feng, Y. Liang, K. Guo, Y. Long, Y. Cong, D. Shen, “Addition of nitrite enhances the electrochemical defluorination of 2-fluoroaniline”, J. Hazard. Mater. 300 (2015) 607-614].

Few examples were reported in the patent literature about the electrochemical degradation of FOCs. In U.S. Pat. No. 5,364,508, Example 6, alkyl fluorocarbon fire extinguishing foam was decomposed electrochemically with tubular graphite cathode, surrounding an inner, concentric rod anode, with sodium bicarbonate used as an electrolyte. US 2007/0138110 reports the electrosorption removal of ammonium perfluorooctanoate from water (the ammonium salt of the abovementioned perfluorooctanoic acid) using an electrolytic cell with stainless steel electrodes (at 6 V DC voltage). US 2012/00055807, Example 1, shows that an initial concentration of 4600 μg/L of PFOS in water was reduced by 98.5% after one hour, with the aid of platinum-plated titanium mesh (anode) and lead rod (cathode), at a voltage of 15 V and current density of 5 A/dm². WO 2022/098432 describes a flow-through electrochemical apparatus for removing fluorinated alkyl from an aqueous stream, using tungsten, titanium, boron-doped diamond, and platinum or gold-plated electrodes.

### SUMMARY

Experimental work reported below shows that the electrochemical removal of FOCs from an aqueous solution is improved greatly by the addition of certain salts to the aqueous stream. That is, with the aid of a salt dissociating in water to supply a reducible cation Mⁿ⁺ that can assume multiple oxidation states (namely, at least Mⁿ⁺ and M^{p+}, n≠p, in addition of course to M⁰) and an oxidizable anion A^{k-}. In many cases, the addition of the Mⁿ⁺ and A^{k-} to the FOC-containing water advances not only the decomposition of the FOC under the applied voltage (where the organic part of the FOC is altered or broken up) but also the cleavage of the C—F bond and fluoride production.

The beneficial effect of the added Mⁿ⁺/A^{k-} combination (usually supplied in the form of a single salt composed of these ions) was observed in conjunction with the application of a voltage across different types of electrodes immersed in the polluted water, i.e., both bare and coated electrodes. Comparative data reported below shows that similar effects (increased FOC degradability and C—F bond cleavability) cannot be achieved with added monovalent cation (e.g., alkali metals) or nonoxidizable anions (e.g., nitrate).

Without wishing to be bound by theory, it is assumed that the applied voltage generates the reduced forms of Mⁿ⁺, i.e., a lower oxidation state M^{(n-x)+}, or the metallic M⁰ form. Both M^{(n-x)+} and M⁰ can potentially donate electrons to reduce the C—F bond, with the restoration of higher oxidation states. This results in a cyclic process, continually supplying reductants that can act on the C—F bond. As to the role of the oxidizable anion, it is converted, e.g., when A^{k-} is chloride, into reactive chlorine species that react with the organic part of the FOC, as indicated by FOC degradation products that were detected in the aqueous solution following the Mⁿ⁺/A^{k-}-aided electrochemical decontamination treatment.

Accordingly, the invention is primarily directed to an electrochemical decontamination method of removing FOC(s) from an aqueous stream, comprising applying an electric voltage across electrodes in contact with the FOC-containing aqueous stream in the presence of Mⁿ⁺ and A^{k-} (n and k are integers), where Mⁿ⁺ is a reducible cation of a transition metal that can assume multiple oxidation states and A^{k-} is an oxidizable anion.

It is usually more effective to add a single source for both Mⁿ⁺ and A^{k-} ions to the aqueous stream, e.g., a suitable water-soluble salt of the transition metal, instead of the addition of two separate salts. In its most general form, the single salt used according to the invention is of the formula (Mⁿ⁺)ₐ(A^{k-})_{b}. In the case of a monovalent anion A⁻ (e.g., chloride, which constitutes the preferred oxidizable anion according to the invention; or bromide) the general formula reduces to MAₙ, e.g., MClₙ. Often such salts form stable hydrates; either anhydrous or hydrated salts can be used. A few preferred examples of MAₙ salts for use as an electrolyte in the invention are tabulated in Table 1.

TABLE 1

| Transition | Oxidation states which | MAₙ added |
|---|---|---|
| metal M | can be assumed by M | (x is from 0 to 6) |
| Iron | +2 (ferrous), +3 (ferric) | FeCl₃•x(H₂O) |
| Nickel | +2, +3, +4 | NiCl₃•x(H₂O) |
| Manganese | +2, +3, +4, | MnCl₂•x(H₂O) |
| Copper | +1 (cuprous), +2 (cupric) | CuCl₂•x(H₂O) |
| Chromium | +2, +3 | CrCl₃•x(H₂O) |
| Cobalt | +2, +3 | CoCl₂•x(H₂O) |
| Tin | +2, +4 | SnCl₂•x(H₂O); SnCl₄•x(H₂O) |

Mⁿ⁺ (e.g., 1 ≤ n ≤ 4) is a cation of a transition metal preferably selected from the group consisting of iron, nickel, manganese, and copper (most preferably iron), and A^{k-} (e.g., 1 ≤ k ≤ 2) is preferably selected from the group consisting of chloride, bromide, sulfide, and azide (most preferably chloride).

The electrochemical degradation of FOCs progresses in an efficient manner, especially in the presence of ferric chloride (FeCl₃, e.g., FeCl₃·6H₂O), nickel chloride (NiCl₂·nH₂O), manganese chloride (MnCl₂·4H₂O) and cupric chloride (CuCl₂ or CuCl₂·2H₂O), all showing high removal rates (conversion percentage exceeding 60% within the test period, with FeCl₃ and CuCl₂ reaching complete conversion). With the aid of ferric chloride and nickel chloride, also surprisingly high fluoride production yields were measured. Ferric chloride emerged as the most useful salt additive from the work reported below.

The method of the invention can benefit from the use of a mixture consisting of two different MAₙ salts, added simultaneously or successively to the polluted aqueous stream. For example, the addition of a first salt, such as CuCl₂, to rapidly decompose the organic part of FOC, with only partial defluorination taking place, followed by the addition of a second salt, such as NiCl₃, to attack the C—F bond.

It is preferred that the (Mⁿ⁺)ₐ(A^{k-})_{b} added to the polluted water would release the transition metal cation in its maximum oxidation number (n>p). However, this is not necessary. For example, in the case of manganese, divalent manganese, rather than tetravalent manganese, was supplied to the contaminated water. In this case, divalent manganese transforms into Mn⁴⁺, then satisfies the above requirement, with Mn²⁺ and Mn⁰ being the two reduced forms that can be obtained from the Mn⁴⁺.

The concentration of the added (Mⁿ⁺)ₐ(A^{k-})_{b} salt in the contaminated water stream is generally in the range from 0.01 to 1.0% by weight, e.g., from 0.05 to 0.5%, assuming that the FOCs concentration in the stream to be treated is less than 100 ppm. Experimental results reported below show that the FOC conversion percentage increases with increasing concentration of the added salt (namely, there is a linear relationship between the degradation of the organic part of the FOC and electrolyte concentration). However, a different trend was observed for the defluorination reaction. Fluoride production (%) versus (Mⁿ⁺)ₐ(A^{k-})_{b} concentration curves exhibit a local maximum. That is, over a low (Mⁿ⁺)ₐ(A^{k-})_{b} concentration interval, fluoride yield increases with increasing salt concentration. But on further increase of the electrolyte concentration, fluoride yield starts decreasing. The unusual trend may be explained by unwanted competing reactions becoming progressively predominant. The unwanted side reactions result in the depletion of the reduced metal forms (M^{(n-x)+} or M⁰), because the reduced forms react with reactive chlorine species, and are less available for the C—F bond cleavage, as explained in more detail below.

The method may comprise adjusting the concentration of the one or more added (Mⁿ⁺)ₐ(A^{k-}) b salt(s) in the contaminated stream so as to maximize both FOC decomposition and fluoride production. An effective (Mⁿ⁺)ₐ(A^{k-})_{b} concentration can be determined by plotting fluoride production (%) as a function of [(Mⁿ⁺)ₐ(A^{k-})_{b}], to locate the maximum. As shown below, the effective concentration of (Mⁿ⁺)ₐ(A^{k-})_{b} is influenced by the type of salt (ratio of the subscripts b:a) and the electrodes used; the relationship shows a maximum in the range from 1:3-1:1 (molar) of FOC: (Mⁿ⁺)ₐ(A^{k-})_{b}.

Turning now to the electrodes which can be used in the invention, high FOC conversion rates and satisfactory fluoride yields were achieved with the application of a voltage across bare and coated electrodes, made of relatively low-cost materials, for example, iron-based electrodes (IBE), including iron alloys such as stainless steel, and copper-based electrodes (CBE), including copper alloys such as bronze. Coated electrodes, e.g., with a thin layer of a noble metal such as palladium, platinum, and gold, deposited on the surface of stainless-steel or copper electrodes, showed slightly increased conversion rates of FOCs as compared to the corresponding bare electrodes. For example, palladium-coated IBE (palladium-coated stainless steel) and palladium-coated CBE are useful in the invention.

To create noble metal coatings on the surface of bare electrodes, either electroless or electrodeposition techniques can be applied. For example, electroless deposition based on the procedure described by G. Stremsdoerfer, J.-M. Krafft, E. Queau, J.-R. Martin, “Wet Technique” Metal Deposition for SEM Observation, Microsc. Microanal. Microstruct. 6 (1995) 393-403] was used to produce 10-30 μm thick layer of palladium on IBE and CBE.

Experimental work reported below shows that IBE, e.g., bare stainless-steel (~60-80% Fe; ~15-20% Cr, ~5-12% Ni, and some carbon, up to 0.08%, e.g., 304 or 304L) or palladium-coated stainless-steel electrodes (labeled Pd@SS), advance the decomposition of the organic part of 5FU in an efficient manner, achieving high decomposition percentage in shorter reaction times, as compared to CBE. Furthermore, in IBE, the fluoride production is comparable to the decomposition percentage, while over CBE electrodes, fluoride production is smaller. IBE outperforms CBE probably due the release of ferrous (Fe²⁺) from the anode; the ferrous ion initiates the reaction effectively. However, the results achieved with CBE are acceptable, and CBE can be used, simply longer treatment times may be needed.

Based on the kinetic study reported below, fluoride production is limited by 5FU degradation, indicating a multi-step degradation reaction. A proposed sequence of reactions is shown below. In the first reaction (reaction (1)), the organic part of the FOC (labeled R) is converted to an intermediate (generally marked as I₁). The C—F bond remains intact in the first reaction; the degradation product of the first reaction is therefore denoted I₁—C—F. The second reaction is characterized by the cleavage of the C—F bond, generating fluoride and non-FOC (P₁) as products. But the organic part of I₁—C—F can undergo further degradation reactions, forming additional compounds, which maintain the C—F bond (dubbed as I₂—C—F in reaction (3)). The non-FOC product P₁ can further be degraded, whereby intermediate P₂ is formed (reaction (4)).

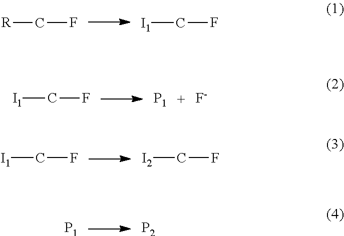

The existence of various intermediate/degradation products was further confirmed by liquid chromatography-mass spectrometry analysis (LCMS) when the reaction mixture was examined for such intermediates, as shown in the experimental section below. The method of the invention is marked by the formation of chlorinated FOC degradation product when the oxidizable anion added to the contaminated stream is chloride.

The addition of chloride salts of transition metals to the FOC-containing aqueous stream (e.g., ferric chloride), generates an acidic pH. It has been found that pH remains roughly constant over the electrochemical decontamination process. With IBE, almost no pH variation is observed. With CBE, the reaction shows a characteristic pH-time profile, with an increase of about 1 to 3 pH units after a while and pH stabilization. Thus, the method of the invention, using IBE and CBE, can be monitored by pH measurement. Stability of the pH indicates that the reaction progresses smoothly. Because pH is a readily measurable process variable, pH monitoring offered by the invention can be exploited on large scale decontamination processes.

Accordingly, the invention is specifically directed to a method of removing FOC(s) from an aqueous stream, comprising applying an electric voltage across IBE or CBE electrodes in contact with the FOC(s)-polluted aqueous stream in the presence of Mⁿ⁺ and A^{k-} as previously defined, optionally under monitoring by pH measurement.

However, the invention is not limited to the use of IBE and CBE electrodes. The electrodes may be constructed of other materials, such as carbon (graphite, graphene-modified carbon felt), titanium (including platinum-coated titanium), mixed metal oxides, gold, boron doped diamond and Pt group electrodes.

The voltage applied across the electrodes, by means of a DC source or a rectifier, is at least 10 V, e.g., from 15 to 30 V, for example, from 18 to 22 V, e.g., around 20 V. Current density at which the method of the invention is carried out is usually from 2 to 10 A/dm² e.g., from 2.5 to 4.5 A/dm². However, cell assemblies can be designed to operate at reduced voltage and low current densities as shown below, e.g., a voltage of 1.5 to 6V. Current density is in the range of 0.03 to 10.0 A/dm², e.g., 0.03 to 2.0 A/dm².

Symmetric electrode configuration is usually preferred, i.e., a pair of electrodes consisting of identical electrodes (e.g., a pair of IBE electrodes, or a pair of CBE electrodes), optionally with polarity reversal, e.g., every 1-15 hour. However, an asymmetric configuration is also acceptable, e.g., the application of a voltage across IBE anode and graphene-modified carbon felt also achieved high FOC(s) conversion and fluoride recovery.

As to the geometry, shape, and structure of the electrodes, it is possible to use an electrolytic cell consisting of a pair of planar (flat) electrodes positioned in parallel to one another, immersed in a stirred batch reactor, e.g., to treat small volumes of contaminated wastewater. On large scale, a reactor design enabling the circulation of the contaminated stream is preferred. For example, a pair of flat electrodes have opposed, spaced apart faces that define a water passage through which the contaminated stream to be treated flows. The distance between the electrodes is, for example, from 5 to 6.5 cm on lab scale. The electrodes are usually identical in shape (e.g., polygonal such as square or rectangular electrodes) and size (with effective electrode area of about not less than about 0.3 m² per 1 m³ liquid).

The method of the invention may be carried out with an electrolytic cell possessing axial symmetry, e.g., with electrodes assembled as nested electrodes in cylindrical configuration. Namely, an outer, cylindrically-shaped electrode provided by a lateral surface of a cylinder, encircling an inner electrode in the form of wire, rod, or hollow tube of smaller diameter. The outer and inner electrodes are coaxially aligned; the contaminated stream is circulated through the annular space located between the outer and inner electrodes.

The electrodes may be provided as smooth plates, foam and meshes. For example, copper is available in all three forms. Mesh electrodes allow the method of the invention to be carried out in a flow-through design, e.g., as shown in US 2012/0055807.

The term “aqueous stream” includes dissolved chemicals (or chemical compounds) in water, and/or water containing suspended material. The invention is well suited for the treatment of wastewater streams produced by pharmaceutical plants, hospital sewage, flame retardants, surfactants, and coating industries, with up to 100-300 ppm FOC. Drinking water suppliers can also use the method to reduce FOCs levels to meet regulatory requirements. Aromatically-bound fluorine, such as 5-fluorouracil and enrofloxacin (a fluoroquinolone antibiotic used to treat bacterial infections), and also aliphatically-bound fluorine, can be degraded by the method.

For example, the method of the invention can be used to reduce contamination of poly- and perfluoroalkyl substances (PFAS) in water. PFAS, e.g., perfluorinated compounds of the formula R—CₙF₂ₙ₊₁ or R′—CₙF₂ₙ—R″ where n is in integer in the range from 3 to 15, e.g., from 5 to 15, and R, R′, R″ are functional groups devoid of carbon or C—F bonds, such as —COOH and —SO₃H, are sometimes divided into long and short chain derivatives. Examples of long chain (n≥5) PFAS include PFOA and PFOS which were mentioned above and perfluorononanoic acid (PFNA; R═COOH, n=8) and perfluorodecanoic acid (PFDA; R═COOH, n=9). As an example of short chain PFAS, perfluorobutanoic acid (PFBA; R═COOH, n=3) may be mentioned.

PFAS contaminate different types of water, not only industrial wastewater streams, but also drinking water such as well and tap water and are usually present as a mixture consisting different PFAS. PFAS are found in drinking water at very low concentrations, which makes it difficult to fully remove them from the water by electrochemical methods with acceptable power efficiency to keep the cost of water treatment low. But regulations about permissible PFAS levels in drinking water are becoming increasingly stringent, and a need exists for an efficient removal of low-concentration PFAS in water.

Experimental results shown below, based on tap water spiked with a range of PFAS, each at a concentration below 10 ppb (levels that approximate PFAS contamination is some types of water, such as well water) indicate that efficient removal of low-concentration PFAS (<10 ppb) from water is attainable by the electrochemical method of the invention, with cell assemblies configured to operate at low current densities.

For example, low concentration PFAS-contaminated water can be treated in a batch electrochemical cell reactor operating at current density lower than 10.0 A/dm² (e.g., <2.0 A/dm², <1.0 A/dm², <0.9 A/dm², <0.5 A/dm², e.g., from 0.03 A/dm² to 0.5 A/dm²), with the Mⁿ⁺ cation and A^{k-} anion present and an electrode stack consisting of plate-shaped electrodes with spacing of ≤1 cm (e.g., 0.5-5.0 mm, e.g., 0.75-2 mm, e.g., ~1 mm) between the electrodes immersed in the water to achieve high removal rates for a range of PFAS (>90%, >95%, and even >99%) over reasonable treatment times.

Accordingly, a specific aspect of the invention is a method comprising applying electric voltage across an electrode stack immersed in an aqueous stream contaminated by one or more PFAS of the formulas CₙF₂ₙ₊₁—COOH) (perfluorinated carboxylic acid) and CₙF₂ₙ₊₁—SO₃H (perfluorinated sulfonic acid), wherein n is independently an integer in the range from 3 to 15, each of said PFAS is present at a concentration below 10 ppb, to pass current at current density in the range from 0.03 to 2.0 A/dm² (e.g., 0.03 to 1.0 A/dm²), in the presence a cation of a transition metal selected from the group consisting of iron, nickel, manganese and copper, and an anion which is chloride and bromide.

Voltage in the range of 1.5 to 6V (e.g., from 2 to 3V) is usually applied by the DC power source. Good results were obtained with an electrode stack consisting of a plurality of bare (uncoated) iron-based electrodes, e.g., stainless-steel electrodes in the shape of plates, which are positioned in parallel (e.g., in a batch container) with (usually equal) spacings as set out above between the electrodes, with effective electrode area of 0.5×10⁻³-3×10⁻² m² per 10⁻⁴ m³ water.

The method of the invention further comprises a step of removing the fluoride from the aqueous stream, e.g., recovering fluoride in a usable form. The fluoride cleaved from FOC can be removed from the aqueous stream with the aid of different membrane, ion exchange, adsorption, and precipitation techniques, as described, e.g., by K. K. Yadav, S. Kumar, Q. B. Pham, N. Gupta, S. Rezania, H. Kamyab, S. Yadav, J. Vymazal, V. Kumar, D. Q. Tri, A. Talaiekhozani, S. Prasad, L. M. Reece, N. Singh, P. K. Maurya, J. Cho, Fluoride contamination, health problems and remediation methods in Asian groundwater: A comprehensive review, Ecotoxicol. Environ. Saf. 182 (2019).

### BRIEF DESCRIPTION OF THE DRAWINGS

FIG. 1 is a bar diagram showing the effect of the different salts (FeCl₃, Fe(NO₃)₃, KCl and KNO₃) on the conversion percentage of 5FU and fluoride production.

FIG. 2 is a bar diagram showing the effects of different electrodes and the presence/absence of FeCl₃ on the conversion percentage of 5FU and fluoride production.

FIGS. 3A-3D show 5FU degradation kinetics with different electrodes: (a) Pd@SS; (b) SS; (c) Pd@Cu; (d) Cu. Filled circles stand for the 5FU removal (in %) for systems with ferric chloride (1 g/L). The hollow circles stand for 5FU removal (in %) for control systems (no ferric chloride). Filled triangles stand for parallel fluoride production with iron chloride. The hollow triangles stand for the control (absent ferric chloride).

FIGS. 4A-4D show pH change during reaction with different electrodes: (a) Pd@SS; (b) SS; (c) Pd@Cu; (d) Cu. Filled circles represent the pH change with ferric chloride (1 g/L), while the hollow circles represent the pH change absent FeCl₃.

FIG. 5 is an LCMS mass-to-charge ratio chromatogram obtained for the experiment of Example 1 after 45 min of the experiment for 0.65 min retention time: (a) negative ionization; (b) positive ionization.

FIG. 6 is an HPLC chromatogram obtained for the experiment of Example 1: (a) at the beginning of an experiment and (b) after 45 min of the experiment.

FIG. 7A shows the effect of FeCl₃ concentration on 5FU degradation kinetics: conversion of 5FU (in %) as a function of time (min), with the application of a voltage across Pd@SS electrodes.

FIG. 7B shows the effect of FeCl₃ concentration on fluoride production (blue, in %) and kinetic constant (in orange, in 1/min), with the application of voltage across Pd@SS electrodes.

FIG. 8 shows the effect of FeCl₃ concentration on fluoride production (application of voltage across Pd@Cu electrodes).

FIG. 9 is a bar diagram showing enrofloxacin, fluometuron, PFOA, PFOS and 5FU degradation and fluoride production under application of a voltage across Pd@SS electrodes using FeCl₃ electrolyte.

FIG. 10 is a photograph showing the experimental set-up used to remove low concentration PFAS from water.

### EXAMPLES

### Materials

Double deionized water (DDW, 18.2 MΩ). Tap water of Weizmann Institute of Science (Rehovot, Israel). Unless stated otherwise, the rest of the materials were purchased from Sigma Aldrich. Fluorouracil (5FU, 99%), sodium bicarbonate (99.5%, Merck), methanol (HPLC grade, J.T. Baker), acetonitrile (99.97%, Biolabs), enrofloxacin (98%) formic acid (98%, J.T. Baker), hydrochloric acid (HCl, 32%, Biolab), iron trichloride hexahydrate (98%), cupric chloride (99%, AnalaR), manganese chloride (99%), nickel chloride NiCl₃ (98%, Merck), iron nitrate nonahydrate (98%) tin chloride dihydrate (97%, AnalaR), palladium chloride (99.9%), PFOA (96%), PFOS (40% in water), PFNA (97%), PFDA (98%), potassium chloride (99%), potassium nitrate, fluometuron (Agan Chemical Manufacturers Ltd). A voltage generator was constructed to provide a potential difference and current as specified below.

### Methods

5FU analysis by UPLC

Acquity™ UPLC binary solvent manager pump equipped with a UV-vis detector (Waters 2489, absorption at 279 nm) and 2.1×100 mm column (Atlantis Premier BEH C18 AX 1.7 μm, Waters) were used. The mobile phase consisted of 95% of 0.1 formic acid and 5% acetonitrile (v/v). Typical run time of 3 min with a flow rate of 0.3 mL/min (pressure of 7000 psi, retention time of around 1.4 min). Standards were prepared with 5FU (concentrations of 1, 5, 10, 50 and 100 mg/L) in DDW. The limit of quantitation (LOQ) was <0.5 mg/L.

### 5FU Analysis by LCMS

Waters Acquity™ UPLC H-class quaternary solvent manager equipped with quantitative detector analysis photo-diode array (QDA-PDA) using ACQUITY Premier Column HSS T3 1.8 μm, 2.1 mm×100 mm. The column was heated to 40° C. The mobile phase is composed of a gradient of 2 solutions: (1) consists of 10% acetonitrile and 90% water (phase A); (2) 90% acetonitrile and 10% water (phase B). Both phases also include 2 mM of ammonium acetate, maintaining its concentration through the gradient. The gradient ranged from 75:25 ratio of phases A:B to 20:80. Analyzing the mass-charge ratio of 128.9 g/(mol×C). 5FU standards were prepared (concentrations of 0.5, 1, 2, 5, 10, 20 μg/L) in DDW. The retention time of 5FU is 1.55 min. The limit of detection is 0.2 μg/L. For the experiments using nickel chloride, manganese chloride and cupric chloride, Waters Acquity™ UPLC H-class quaternary solvent manager equipped with QDA-PDA using ACQUITY Premier Column HSS T3 1.8 μm, 2.1 mm×100 mm. The column was heated to 40° C. The mobile phase is composed of the gradient of 2 solutions: (1) consists of 100% water (phase A); (2) 90% acetonitrile 10% water (phase B). Both phases also include 2 mM of ammonium acetate, maintaining its concentration through the gradient. The gradient ranged from 96:4 ratio of phases A:B to 50:50. Analyzing the mass-charge ratio of 128.9 g/(mol×C). 5FU standards were prepared (concentrations of 1, 5, 10,5,100 mg/L and were diluted 1:1000) in DDW. The retention time of 5FU was 1.8. The detection limit was 0.2 mg/L.

### Enrofloxacin Analysis by UPLC

Acquity™ UPLC binary solvent manager pump equipped with a UV-vis detector (Waters 2489, absorption at 280 nm) and 2.1×100 mm column (Atlantis Premier BEH C18 AX 1.7 μm, Waters) were used. The mobile phase consisted of 80% of 0.1% formic acid and 20% acetonitrile (v/v). Typical run time of 5 min with a flow rate of 0.3 mL/min (pressure of 6000 psi, retention time of 2.6 min). Standards were prepared with enrofloxacin (concentrations of 0.6, 3, 6, 30 and 60 mg/L) in DDW. LOQ was <0.03 mg/L. Enrofloxacin conversions were determined with the highest enrofloxacin concentration during the reaction, rather than the initial concentration.

### Fluometuron Analysis by UPLC

Acquity™ UPLC binary solvent manager pump equipped with a UV-vis detector (Waters 2489, absorption at 260 nm) and 2.1×100 mm column (Atlantis Premier BEH C18 AX 1.7 μm, Waters) were used. The mobile phase consisted of 55% of 0.1% formic acid and 45% acetonitrile (v/v). Typical run time of 5 min with a flow rate of 0.3 mL/min (pressure of 5000 psi, retention time of 3 min). Standards were prepared with fluometuron (concentrations of 0.4, 2, 4, 20, 40 mg/L) in DDW. LOQ was 0.3 mg/L.

### PFAS Analysis by LCMS

Waters Acquity™ UPLC H-class quaternary solvent manager equipped with quantitative detector analysis photo-diode array (QDA-PDA) using ACQUITY UPLC BEH C18 Column, 130 Å, 1.7 μm, 2.1 mm×50 mm. The mobile phase is composed of the gradient of 2 solutions: (1) consists of 10% acetonitrile and 90% water (phase A); (2) 90% acetonitrile and 10% water (phase B). Both phases also include 2 mM of ammonium acetate, maintaining its concentration constant through the gradient. The gradient ranged from 75:25 ratio of phases A:B to 20:80. Analyzing the mass-charge ratio of 413 and 499 g/(mol×C). PFOA and PFOS standards were prepared (concentrations of 0.5, 1, 5, 10, 50 and 100 mg/L) in DDW. The retention time of PFOA and PFOS were 1.7 and 2.8 min, respectively. Each sample was diluted 1:104 prior to running in LC-MS. LOD was 10 μL containing 0.1 μg/L. PFOS conversions were calculated with the highest PFOS concentration during the reaction, rather than the initial concentration. For the low concentration experiments, the same method was used but the gradient ranged from 100:0 ratio of phases A:B to 20:80. The PFAS molecules (PFOA, PFOS, PFNA and PFDA) had exit times of 4, 4.5, 5 and 5.1 minutes, respectively, and analysis mass of 413, 463, 513, 499, respectively. The concentration standards prepared were of 0.1, 0.5, 1, 5, 10, 50 μg/L (i.e. 0.1-50 ppb). Column temperature of 40 C. Samples were not diluted.

### Fluoride Analysis by HPLC

Waters 1525 binary HPLC pump equipped with conductivity detector (Alltech, model 650) and 10 μm 2.1×150 mm (Hamilton PRP×100 column) was used. Mobile phase-sodium bicarbonate (1 g/L). The pressure was kept at 2000 psi (flow rate ranges of around 2 mL/min). Retention time around 2-3 min (run time of 12 min, includes cleansing of iron salt residue). Standards were prepared with either sodium fluoride or potassium fluoride (concentrations of 1, 5, 10, 50, 100 mg/L) in DDW. The limit of detection (LOD) was 0.3 mg/L. For the experiments using nickel chloride, manganese chloride and cupric chloride, fluoride concentrations were measured via UPLC (Waters Acquity™ binary solvent manager pump) equipped with a conductivity detector (Alltech, model 650) and 10 μm 2.1×150 mm (Hamilton PRPX100 column). The mobile phase consisted of 98:2 DDW:methanol (by weight), p-hydroxybenzoic acid 4 mM, and sodium thiocyanate (NaSCN) 0.1 mM. The pH was adjusted to 8.81 by NaOH. The flow rate was 1.1 mL/min (around 3500 psi). Standards were prepared with sodium fluoride (concentrations of 2, 4, 10, 20.40 mg/L) in DDW. The limit of detection was a bit lower than 1 mg/L fluoride.

### 5FU Degradation Products/Intermediates by LCMS

Waters Acquity™ UPLC H-class quaternary solvent manager equipped with QDA-PDA using ACQUITY Premier HSS T3 Column 1.8 μm, 2.1×100 mm. The mobile phase is composed of a gradient of 2 solutions: (1) consists of 10% acetonitrile and 90% water (phase A); (2) 90% of acetonitrile and 10% of water (phase B). Both A and B solutions included 2 mM ammonium acetate for negative ionization and 0.05% formic acid for positive ionization. The gradient ranged from a 75:25 ratio to 20:80 of phases A:B. A flow rate is 0.4 mL/min. QDA-PDA analyzes mass-charge ratio in the range of 100-250 g/(mol×C).

### Preparation 1

### Preparation of Palladium-Coated Stainless-Steel Electrodes (Pd@SS)

Stainless steel (304L) plates, rectangular in shape (6 cm×2 cm) were polished with 1M HCl. Next, the following coating procedure was carried out. The electrodes were immersed in a 100 mL solution of 0.4 M HCl with 1 g of SnCl₂ for 5 min. The electrodes were dipped in DDW for 1 second and then dipped in a solution of 0.1 M HCl with 0.5 g/L PdCl₂ for 15 min. The electrodes were dried in an oven for half an hour at 105° C. The coating procedure was repeated twice, resulting in the deposition of 3.5 cm×2 cm black layer of palladium, over each face the stainless-steel electrodes.

### Preparation 2

### Preparation of Palladium-Coated Copper Electrodes (Pd@SS)

Copper plates, rectangular in shape (6 cm×2 cm), were polished with 1 M HCl. Next, the following coating procedure was carried out. The electrodes were immersed in a 100 mL solution of 0.4 M HCl with 1 g of SnCl₂ for 5 min. The electrodes were dipped in DDW for 1 second and then dipped in a solution of 0.1M HCl with 0.5 g/L PdCl₂ for 5 min. The electrodes were dried in an oven for half an hour at 105° C. The coating procedure was repeated twice, resulting in the deposition of 3.5 cm×2 cm black layer of palladium over each face the Cu electrodes.

### Example 1 (of the Invention) and 2 to 4 (Comparative)

### Electrochemical Degradation of 5-Fluorouracil in Different Electrolyte Solutions (FeCl₃, Fe(NO₃)₂, KCl and KNO₃)

A series of experiments was carried out to study the effect of different types of salts on the electrochemical degradation of 5FU, namely, 1) the conversion percentage of 5FU and 2) the fluoride production percentage from the degraded 5FU.

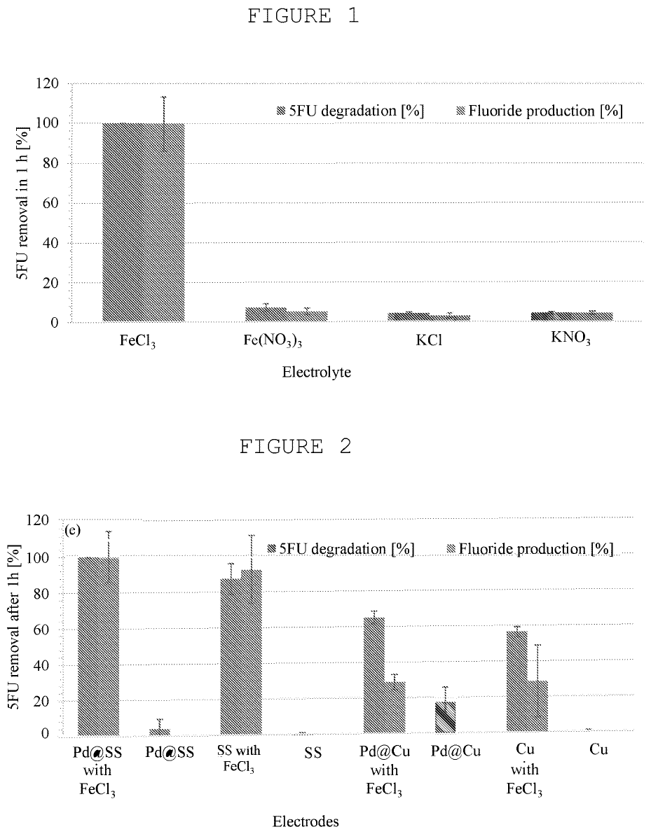

A beaker was charged with 100 mL of an aqueous solution of 5FU (100 mg/L). A pair of Pd@SS electrodes of Preparation 1 were placed 6.5 cm apart from each other in the solution. The initial concentrations of the electrolyte solutions are tabulated below, expressed as g/L. The electrodes were connected to a DC power source and a voltage of 20 V was applied across the electrodes, passing an electric current of 0.4 A for 1 h. Stirring speed was 350 rpm. Each experiment was performed in triplicate. The results are tabulated in Table 2 and shown graphically in the form of a bar diagram appended as FIG. 1 (each salt is associated with a pair of adjacent bars; the left bar indicates 5FU conversion rate and the right bar indicates fluoride production).

TABLE 2

| | | | 5FU | |
|---|---|---|---|---|
| | | Initial salt | conversion | |
| | | Concentration, | after 1 h, | Fluoride |
| Example | Added salt | g/L | % | production |
| 1 (invention) | FeCl₃•6H₂O | 1 | 100 ± 0 | 100 ± 13 |
| 2 (comparative) | Fe(NO₃)₃ | 1.5 | 7 ± 2 | 5 ± 2 |
| 3 (comparative) | KCl | 1.36 | 4.2 ± 0.5 | 3 ± 1 |
| 4 (comparative) | KNO₃ | 1.12 | 4.4 ± 0.4 | 4.4 ± 0.7 |

It is seen that in a ferric chloride electrolyte solution, not only that 5FU was degraded completely, but the C—F bond was cleaved with fluoride production reaching 100% conversion. Replacing ferric chloride with other salts resulted in poor degradation overall, with less than a 7% conversion rate (and comparable fluoride production). The results indicate that for an electrochemical degradation of fluorinated organic compounds to advance effectively, the combination of a reducible metal cation (Mⁿ⁺) having multiple oxidation states (Mⁿ⁺ and M^{p+}, n≠p) and an oxidizable anion (e.g., chloride) are needed. That is, ferric chloride acts as a two-face reactant; the ferric ion is reducible to ferrous or Fe⁰ while chloride generates reactive chlorine species. In contrast, potassium cannot be reduced in aqueous solution and nitrate does not generate any oxidizing species.

### Examples 5 to 7 (of the Invention)

### Electrochemical Degradation of 5-Fluorouracil in Different Electrolyte Solutions (NiCl₃, MnCl₂ and CuCl₂)

A series of experiments was carried out to test the effect of salts of the formula MClₙ, where M is a transition metal with multiple oxidation states, on the electrochemical degradation of 5FU, namely, 1) conversion percentage of 5FU and 2) fluoride production percentage from the degraded 5FU.

The experimental procedure set forth in Examples 1~4 was repeated (application of a voltage across Pd@SS electrodes of Preparation 1 immersed in 100 mL solution of 100 mg/L 5FU over one hour, 350 rpm). The amount of salt added was equimolar to the amount of 0.1% iron chloride. Each experiment was performed in triplicates. The results are shown in Table 3.

TABLE 3

| | | | | 5FU | |
|---|---|---|---|---|---|
| | | Initial salt | | conversion | Fluoride |
| | | conc., | | after 1 h, | production, |
| Example | Electrolyte | g/L (mM) | | % | % |
| 5 | NiCl₃•6H₂O | 1 | (0.37 mM) | 80 ± 20 | 70 ± 20 |
| 6 | MnCl₂•2H₂O | 0.73 | (0.37 mM) | 60 ± 30 | 22 ± 3 |
| 7 | CuCl₂•2H₂O | 0.63 | (0.37 mM) | 100 ± 0 | 19 ± 7 |

The results indicate that the electrochemical degradation of 5FU proceeds effectively in the presence of salts of the formula MClₙ, where M is a transition metal with multiple oxidation states, reaching conversion rates from 60 to 100%. All tested salts were also able to advance fluoride production, with nickel chloride in particular showing fairly high fluoride yield.

### Examples 8-11

### Electrochemical Degradation of 5-Fluorouracil Using Different Electrodes in the Presence and Absence of FeCl₃: Kinetic Study

A series of experiments was carried out to study the effects of different electrodes and the presence of FeCl₃ on the electrochemical degradation of 5FU, namely, 1) the conversion percentage of 5FU and 2) fluoride production percentage from the degraded 5FU. Stainless-steel and copper electrodes were tested, either bare electrodes (labeled SS and Cu, respectively) or with palladium coating deposited thereon (of Preparations 1 and 2; labeled Pd@SS and Pd@Cu, respectively). The experiments were performed using 100 mL of an aqueous solution of 5FU (100 mg/L). The pair of tested electrodes were immersed in the solution, placed 6.5 cm apart from each other. The electrodes were connected to a DC power supply, applying a voltage of 20 V and current of 0.4 A for 1 h (350 rpm). Samples (4 mL) were collected every five minutes and analyzed for 5FU and fluoride concentrations. For each electrode type, electrochemical degradation of 5FU was studied with and without FeCl₃ (as the hexahydrate; 1 g/L, 0.1 wt. %, 0.37 mM). Each experiment was done in triplicates; see Table 4.

TABLE 4

| | | added |
|---|---|---|
| Example | Electrode | FeCl₃ |
| 8A* | Palladium-coated stainless steel of Preparation 1 | yes; 1 g/L |
| | labeled: Pd@SS with FeCl₃ | |
| 8B | Palladium-coated stainless steel of Preparation 1 | no |
| | labeled: Pd@SS | |
| 9A | stainless steel (bare; 304 L) | Yes; 1 g/L |
| | labeled: SS with FeCl₃ | |
| 9B | stainless steel (bare; 304 L) | no |
| | labeled: SS | |
| 10A | Palladium-coated copper of Preparation 2 | Yes; 1 g/L |
| | labeled: Pd@Cu with FeCl₃ | |
| 10B | Palladium-coated copper of Preparation 2 | no |
| | labeled: Pd@Cu | |
| 11A | Copper (bare, smooth) | Yes; 1 g/L |
| | labeled: Cu with FeCl₃ | |
| 11B | Copper (bare, smooth) | no |
| | labeled: Cu | |

Example 8A corresponds to Example 1

Overall 5FU degradation and fluoride production achieved in 1 h is shown in FIG. 2. The results are shown in the form of adjacent pairs of bars for each Example. The left (blue) and right (red) bar in each pair of bars indicate the conversion percentage of 5FU and fluoride production percentage, respectively.

Regarding the effect of added salt, again the results in FIG. 2 demonstrate the ferric chloride (FeCl₃) importance for the process, irrespective of the electrode involved. Without it, 5FU hardly degraded and even if was degraded, it is probably due to C—H activation reaction which can be induced by Pd (i.e., in the case of Pd@SS; this, however, does not produce fluorides). In the presence of FeCl₃, good conversion rates of 5FU were achieved for all types of electrodes, namely, iron based and copper based electrodes, either bare or coated.

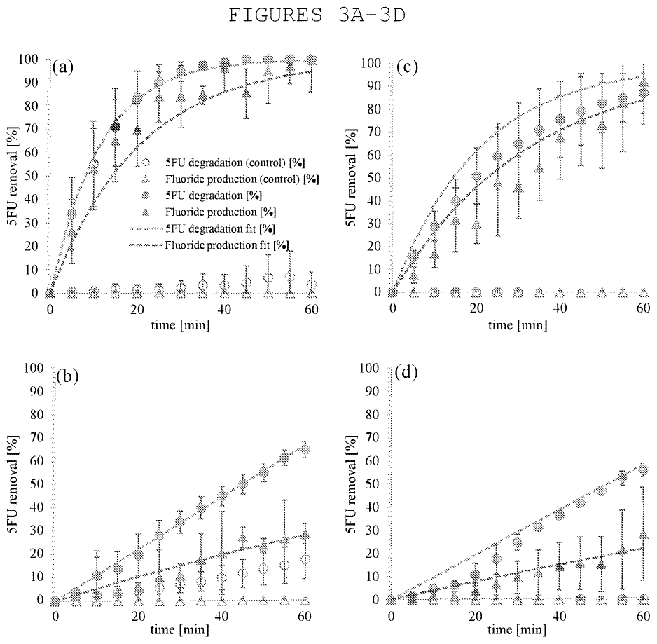

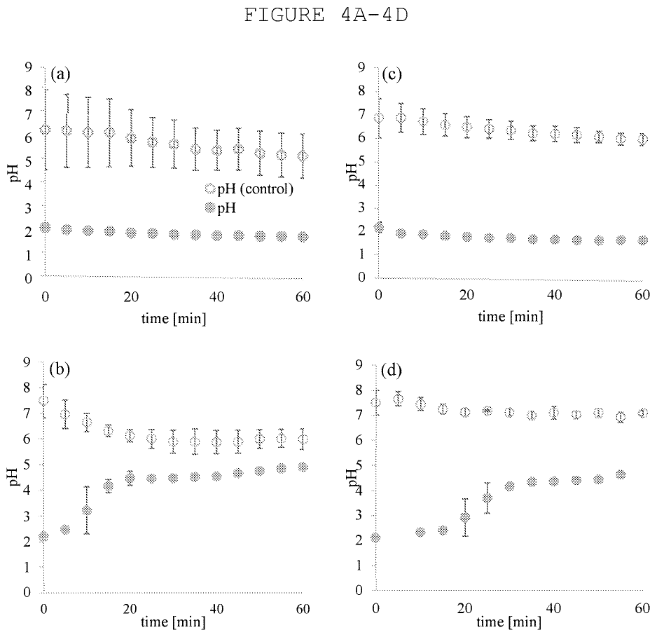

Regarding the effect of electrodes, degradation kinetics and pH variation were measured. The samples that were collected at five minutes intervals over the one-hour test period were analyzed for 5FU concentration and fluoride concentration and corresponding 5FU conversion (%) and fluoride yield (%) versus time plots were created (FIG. 3). In addition, pH versus time plots were created (FIG. 4).

### Degradation Kinetics

FIG. 3 shows the degradation kinetics with the different electrodes: (a) Pd@SS; (b) SS (c) Pd@Cu; (d) Cu. Filled circles represent the removal of 5FU (%) for systems with FeCl₃. The hollow circles represent the removal of 5FU (%) absent FeCl₃. Filled triangles represent the parallel fluoride production with FeCl₃. The hollow triangles represent fluoride production (%) absent FeCl₃.

Rapid degradation of 5FU was observed with iron-based electrodes (Pd@SS and SS). The Pd@SS electrode (FIG. 3a) degraded 50% of 5FU in ~10 min and reached 100±0% removal after 30 min. The method is slightly slower with SS (FIG. 3b), but still, the results were very good, with the SS electrode achieving 50% degradation in ~20 min and reaching 87±9% in 60 min. Fluoride production follows a similar trend indicating that the method is capable of breaking the C—F bond almost stoichiometrically. The Pd@SS produced 50% fluorides in about 10 min and reached saturation of 100% at about 40 min (100±13% after 60 min). SS produces 50% fluoride after ~25-30 min and reaches 92±18% after 60 min.

5FU degradation was achieved by the application of voltage across copper-based electrodes, though slower reaction rates were measured compared to iron based-electrodes. In iron-based electrodes, the rapid degradation fits 1^{st} order kinetics. In copper-based electrodes, the kinetics fits the 0th order kinetics. Table 5 shows the kinetic constants and coefficient of determination (R²) for the reactions with different electrodes. The kinetic constants for iron-based electrodes (and fluoride production in copper-based electrodes) were calculated from linear regression (−ln(1−_{conversion} [%]/100)=kt) while fixing the intercept at the origin (the kinetic constant being the slope). In copper-based electrodes, the linear regressions were calculated regularly without fixing the intercept (with negative inverse 5FU concentrations in mg/L vs. time in min). The kinetic constant is the slope in this case as well.

TABLE 5

| | 5FU degradation | | F⁻ production | |
|---|---|---|---|---|
| Electrode type | k [1/min] ^{a)} | R²_{5FU} | k [1/min] ^{a)} | R²_{F}_{^{−}} |
| Pd@SS | 0.089 ± 0.002 | >0.99 | 0.049 ± 0.003 | 0.96 |
| SS | 0.0487 ± 0.008 | >0.99 | 0.031 ± 0.002 | 0.95 |
| Pd@Cu | 1.18 ± 0.02 ^{b)} | >0.99 | 0.49 ± 0.03 | 0.97 |
| Cu | 1.04 ± 0.04 ^{b)} | 0.98 | 0.216 ± 0.008 | 0.98 |

^{a)} the intercept was fixed at the origin;
^{b)} Calculated 0^{th} order, the kinetic constants are in units of mg/(L × min)

### pH Variation

Turning now to pH variation during the reaction with different electrodes, in the presence and absence of FeCl₃, the results are shown in FIG. 4: a) Pd@SS, (b) Pd@Cu, (c) SS and (d) Cu. The filled circles in FIG. 4 represent the pH change with ferric chloride, while the hollow circles represent the pH change in reactions devoid of ferric chloride.

The addition of FeCl₃ to water generates acidic pH (the initial pH in all experiments was ≈2). The acidic pH results from the precipitation reaction of the water insoluble iron hydroxide, as seen in the following reaction equation:

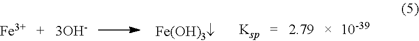

Based on the water dissociation constant and the solubility product constant, the pH should be roughly 2.29. It is seen that the initial pH in all experiments was ≈2—see FIGS. 4a-4d.

With the IBE electrodes, the pH remained roughly constant over the one-hour experiment period (FIGS. 4a and 4c).

With the CBE electrodes, a rise in pH occurred 10-15 minutes after the experiment started, suggesting that some time is required for initiating the degradation of 5FU. Subsequently, the pH was stabilized at ~4.5. The pH increase, observed for CBE and not for IBE electrodes, can be a result of the following hydroxide-generation reaction:

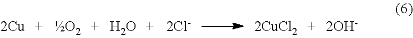

The reaction of equation (6) can explain the shorter delay in pH rise seen in the palladium-coated Cu electrode as compared to the bare Cu electrode. Reaction (6) is limited only by the copper and charge transfer. Due to higher palladium electrical potential (0.987 V vs. 0.337 V of copper), the charge transfer is faster on Pd@Cu, which explains why the pH jump (from 2.1 to ~4.5) started ten minutes earlier compared to bare Cu.

In the FeCl₃-free experiments, the initial pH was nearly neutral. pH changes occurred due to the dissolution of carbon dioxide in the water, to give carbonic acid.

### 5FU Degradation Products

The results reported above indicate that 5FU degradation and fluoride production are not comparable in all cases, i.e., not every molecule of degraded 5FU produces fluoride. This finding suggests the formation of several 5FU degradation compounds, i.e., intermediate(s) and/or by-products presumably with varying cleavability of the C—F bond.

To detect such intermediate(s), the reaction of Example 8A was selected (electrochemical degradation of 5FU by palladium-coated stainless-steel electrodes aided by FeCl₃). The sample that was collected forty-five minutes after the reaction started was analyzed to determine 5FU degradation products. That is, to capture “snapshots” at an appropriate reaction stage, before the reaction reached 100% conversion and stochiometric formation of fluorides.

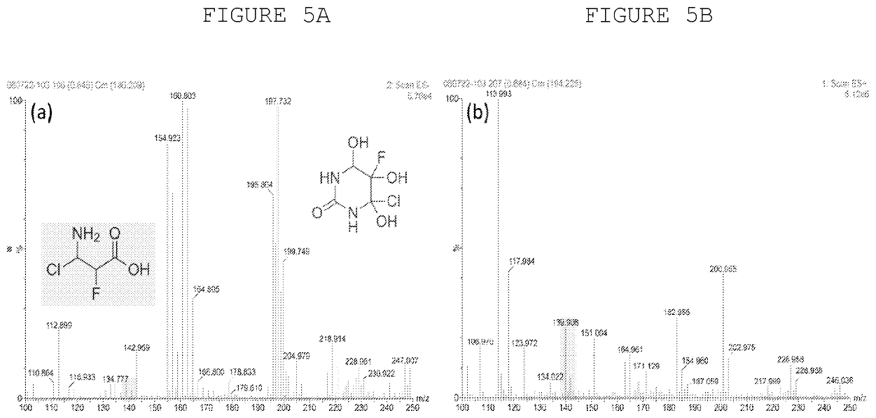

Degradation intermediates/by-products were determined in the sample by liquid chromatography-mass spectrometry. Many different compounds were observed, as seen from the chromatograms in FIG. 5 (mass-to-charge ratio chromatograms in different ionization mode for 0.65 min retention time). Each chromatogram shows different ionization, including possible compounds as intermediates (marked in blue and yellow): (a) negative ionization; (b) positive ionization. The chromatograms show the relative part (in %) of the counts of each intermediate relative to the highest count as a function of molar mass-charge ratio (in g/(mol×C))).

It is seen that all the compounds that have X.9 g/(mol×C) contain fluorides. Some intermediates (marked in blue and yellow) also contain chloride fingerprints—X.8 g/(mol×C) and 2:1 isotopic ratio, indicating the formation of reactive chlorine species (RCS), which in turn act on the organic part of the 5FU. Compounds with matching molar mass are also included; they can result from different types of chemical reactions. The 5FU degradation process involves no polymerization reactions, as no double (or higher) charged compounds were identified.

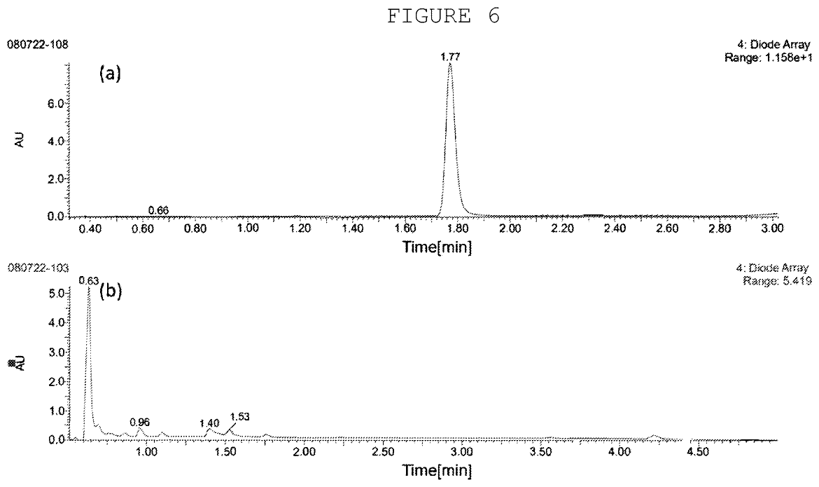

The 5FU peak in the UV spectrum (retention time of 1.77 min in FIG. 6a) completely vanished after forty-five minutes of exposure to the electrochemical treatment. A few peaks at different retention times arose at 0.63, 0.96, 1.4, and 1.56 minutes (FIG. 6b), indicating the formation of several 5FU degradation products. Using LCMS, traces of molecules with different mass-to-charge ratios (such as 138.9 and 198.7 g/(mol×C)) can be distinguished, as depicted in FIG. 5. No double charges were observed (even in different retention times of 0.57, 1.55 and 4.24 min), which implies that only small molecules (not polymerized) are present in the solution. Furthermore, the lack of double charge implies that each mass-to-charge ratio is normalized to one charge, i.e., each mass-to-charge ratio is almost the molar mass of the compound (with a lack of proton in negative ionization or additional proton in positive ionization).

All peaks/counts that include nine-tenths (X.9) g/mol indicate that the intermediate molecules contain a fluorine atom. In addition, the intermediates (138.9 marked and 198.7 g/mol marked) indicate the presence of an intermediate, including fluorine and chlorine atoms. Peaks that include a smaller peak (with an additional 2 g/mol) with a ratio of 1:2 implies the presence of chlorine. This pattern is characteristic of the isotopic difference of chlorine (35 and 37, with a ratio of 2:1). These peaks can also be seen in positive ionization, indicating that chlorine is indeed present. The UV absorption is given by arbitrary units.

### Example 12

### Electrochemical Degradation of 5-Fluorouracil in FeCl₃ Electrolyte Solution Under Different Salt Concentrations

A series of experiments was carried out to study the effect of different FeCl₃ concentrations on 1) conversion of 5FU (in %) as a function of time and 2) fluoride production. FeCl₃ concentration effect was studied for the electrochemical degradation induced by palladium-coated stainless-steel electrodes (Part A) and palladium-coated copper electrodes (Part B).

### Part A: 5FU Degradation by Pd@SS Electrodes

The experimental procedure set forth in Examples 1 and 9 A was repeated (initial 5FU concentration in the aqueous solution was 100 mg/L; application of a voltage across Pd@SS electrodes of Preparation 1, over one hour, 350 rpm). Four concentrations of ferric chloride in the solution were tested: 0.05%, 0.10%, 0.20% and 0.40% (by weight). The reaction was sampled every 5 min to collect 4 mL samples which were analyzed. Each experiment was done in triplicates. The degradation of 5FU in a ferric chloride-free solution was also measured.

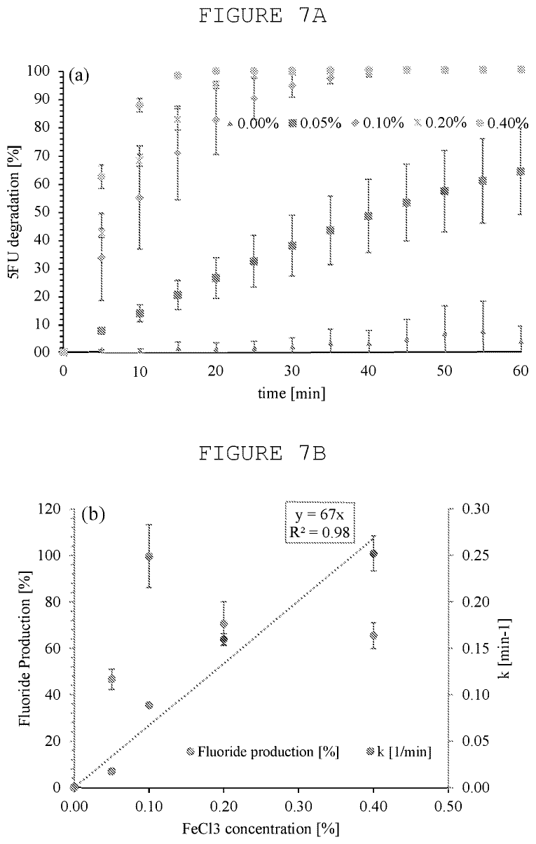

The results are shown graphically in FIG. 7A, as 5FU conversion rate (%) versus time plots (a total of five plots, marked by orange circles (0% FeCl₃), yellow squares (0.05% FeCl₃), blue rhombuses (0.10% FeCl₃), green exes (0.20% FeCl₃) and grey circles (0.40% FeCl₃). The results indicate that the 5FU conversion rate is determined by the ferric chloride presence. The higher the ferric chloride concentration, the faster the 5FU conversion reactions, as seen in FIG. 7A.

Turning now to FIG. 7B, the abscissa is the FeCl₃ concentration and the right ordinate is the kinetic constant of the 5FU conversion. The iron chloride concentration dependency is reflected by the kinetic constant, as seen in FIG. 7B (in orange).

In FIG. 7B, the left ordinate corresponds to the percentage of fluoride production (in blue circles). The trend shown in FIG. 7B is different from the one in FIG. 7A, i.e., there is no linear relationship between FeCl₃ concentration and fluoride yield. Across a low FeCl₃ concentration interval, say, up to 0.10%, fluoride yield increases with increasing FeCl₃ concentration. But on moving to higher FeCl₃ concentrations, fluoride yield decreases. It appears that in higher iron chloride concentrations (e.g., >0.15%), the probability of reduced iron forms (Fe²⁺ or Fe⁽⁰⁾) reacting with reactive chlorine species is much higher than reacting with the FOC (or its intermediates), which overall slows the fluoride production. That is, with iron:chloride ratio of 1:3 characteristic of FeCl₃, a higher concentration of reactive chlorine species is generated, which enhances the degradation of the organic part of 5FU leading to higher reaction rates observed in FIG. 7A. However, at the same time, the reduced forms of iron are more readily oxidized by the reactive chlorine species. Then, the reduced iron is “wasted” and oxidized on chlorine species, instead of targeting the fluoride, resulting in poorer fluoride production overall.

### Part B: 5FU Degradation by Pd@Cu Electrodes

The dependency of fluoride production on FeCl₃ concentration was studied for Pd@Cu electrodes as well.

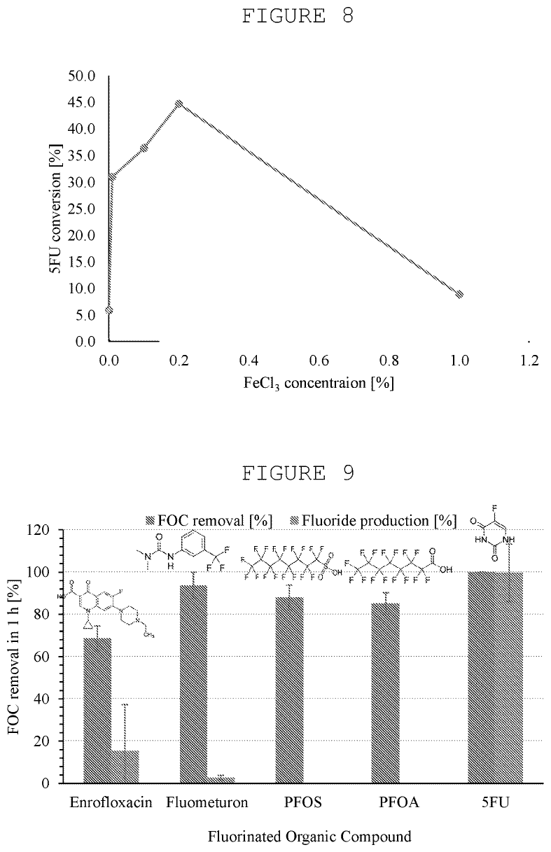

Different FeCl₃ concentrations were examined—0, 0.01, 0.1, 0.2 and 1 wt. % of FeCl₃ to produce fluorides from 5FU degradation in 2 h. Fluoride production behavior was like the behavior observed for the Pd@SS electrode (Part A)—increase in fluoride production up to an optimum and then decrease. The optimum was 0.2 wt. % of FeCl₃, unlike for Pd@SS, which was 0.1 wt. %. The fluoride yield versus FeCl₃ concentration plot is shown in FIG. 8.

### Example 13

### Electrochemical Degradation of 5-Fluorouracil in FeCl₃ Electrolyte Solution Using Stainless-Steel Electrode in an Asymmetric Configuration

The voltage of 20 V and current of 0.4 A were applied for two hours across a graphene-modified carbon felt cathode and stainless-steel anode connected to the positive and negative terminals of a DC power source. The electrodes were immersed in 100 mL of an aqueous solution of 5FU at a concentration of 100 mg/L; 350 rpm). At the end of the two hours period a fluoride production percentage of 74.1% was determined.

### Examples 14-17

### Degradation of Different FOCs

Electrochemical degradation of enrofloxacin, fluometuron, PFOS and PFOA by the method of the invention was studied. The experiments were performed using 100 mL of an aqueous solution of the FOC (initial FOC concentration: 60 mg/L for enrofloxacin, 40 mg/L for fluometuron (both due to solubility limitations), and 100 mg/L for PFOA and PFOS). The solution was treated with Pd@SS electrodes of Preparation 1 at the applied voltage of 20 V and current of 0.4 A for 1 h; 350 rpm. FeCl₃ was added to the solution addition (1 g/L, 0.1 wt. %, 0.37 mM). Each experiment was done in triplicates. The solutions were sampled and analyzed every five minutes.

Overall degradation of different FOCs (enrofloxacin—Example 14, fluometuron—Example 15, PFOA—Example 16, PFOS—Example 17) under applied voltage is shown in FIG. 9 (left bar, in %) and fluoride production (right bar, in %). All FOCs were degraded using the method of the invention, proving its applicability to a variety of FOCs. Applied voltage enabled degradation in 1 h of 68±6% of the enrofloxacin, 93±7% of the fluometuron, 88±6% of PFOS and 85±5% of PFOA. Traces of fluoride production could be found in the fluometuron experiments (3±1%). For enrofloxacin, 15% is the average of triplicate, but conversion ranged from 0 to 46%. In the cases of PFOA and PFOS, fluoride was not observed.

Additional experiments were completed with minimum disturbance to confirm that sampling indeed caused some of PFOS and PFOA to redissolve into the solution, thus disturbing the separation/Electrocoagulation (EC, or electro-flocculation) process. Under these conditions, PFOA conversions began at 80.7±0.7% and increased after 1 h to 95.3±0.7%. The PFOS conversion began at 86±6% and increased to 98±3%.

The degradation of all FOCs fits well with 1st order kinetics, as summarized in Table 6. The concentration dependency is expected, as phase separation depends on solution composition. The 1^{st} order kinetics might imply on possible dependency on other solution properties, such as iron chloride concentration or the external voltage.

TABLE 6

| Example | FOC | k [1/min] | R² |
|---|---|---|---|
| 14 | Fluometuron | 0.044 ± 0.003 | 0.98 |
| 15 | Enrofloxacin | 0.018 ± 0.001 | 0.96 |
| 16 | PFOA | 0.0086 ± 0.0003 | 0.99 |
| 17 | PFOS | 0.01634 ± 0.0001 | >0.99 |

The linear fits were obtained with correlation coefficients higher than 0.96; 1^{st} order kinetics indicate that the partitioning process via EC depends on the contaminant concentration. In general, solution composition is a crucial factor in separation processes. In other words, it is expected that there will be some dependence on concentration during phase separation. The linear dependency of the rate (resulting in 1st order kinetics) might imply additional dependency, akin to 1st order chemical reaction. The dependency can be either the external voltage, salt concentration (which is in excess) or water.

The regression was done with relative parameters: relative time with respect to lag time (time difference) and relative conversion with respect to the concentration at 10 min (concentration differences), and with the intercept fixed at the origin:

$$- ln ( 1 - \frac{conversion [ \% ] - conversion [ \% ] {\vert}_{t = 10}}{100} ) = k ( t - {t}_{DeadTime} )$$

### Examples 18-20 (Comparative) and 21-23 (of the Invention)

### Low Concentration PFAS Removal from Water

A series of experiments was carried out to study the electrochemical removal of <10 ppb PFAS from drinking water with the aid of suitably selected salts.

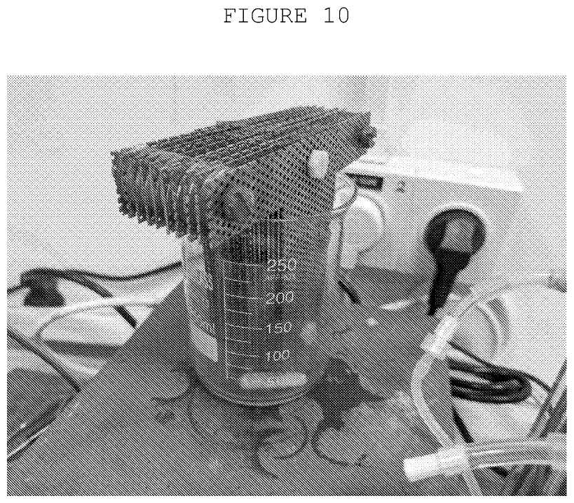

The cell assembly (shown in FIG. 10) included a batch container (a 250 mL beaker) and an electrode stack consisting of ten stainless steel (304L) perforated plates. The electrodes (polished with 1M HCl before use) were immersed in 120 mL of tap water, to which were added one or more PFAS at initial concentrations tabulated below.

The submerged electrode section was rectangular in shape (~4 cm×6 cm). The electrodes were arranged in parallel; the distance between adjacent electrodes was ~1 mm. The total effective surface area of the electrodes (i.e., immersed in the water) was about 300 cm². The electrodes were connected to a DC power source. A voltage, set in in range of ~2V-4V, was applied across the electrodes, passing an electric current of 0.1 to 1 A for 1 h, as tabulated below. Stirring speed was 350-700 rpm.

The comparative experiments were conducted without an added salt (Example 18-19) or with addition of a salt of an alkali metal (Example 20). In the experiments of the invention (Examples 21-23), salts of transition metals of the formula (Mⁿ⁺)ₐ(A^{k-}), were added to the PFAS-contaminated water (FeCl₃ and FeBr₂) or a transition metal salt in which the counter anion was a non-oxidizable anion, to test if the natural salinity of the water can sufficiently advance a decontamination effect. The conditions and results of the experiments are set out in Table 7.

TABLE 7

| | PFAS in tap water, | Added | Current, | C_{final}/Cᵢₙᵢₜᵢₐₗ |
|---|---|---|---|---|
| Ex | Cᵢₙᵢₜᵢₐₗ, ppb | salt, ppm | voltage | Ratio in % |
| 18 | PFOA, 8 ppb | no salt | 0.1 A, 2.4 V | 80% |
| 19 | PFOA, 13 ppb | no salt | 1 A, 4 V | 45% |
| 20 | PFOA, 6 ppb | NaCl, 200 ppm | 0.1 A, 2.4 V | 73% |
| 21 | PFOA, 6 ppb | FeCl₃, 500 ppm | 0.1 A, 2.2 V | <1% |
| | PFOS, 3 ppb | | | <1% |
| | PFNA, 4 ppb | | | <1% |
| | PFDA, 2 ppb | | | 2% |
| 22 | PFOA, 6 ppb | FeBr₂, 400 ppm | 0.1 A, 2.4 V | <1% |
| | PFOS, 3 ppb | | | <1% |
| | PFNA, 3 ppb | | | <1% |
| | PFDA, 2 ppb | | | 2% |
| 23 | PFOA, 6 ppb | FeSO₄, 500 ppm | 0.1 A, 2.4 V | <37% |
| | PFOS, 4 ppb | | | <1% |
| | PFNA, 4 ppb | | | 5% |
| | PFDA, 2 ppb | | | 2% |

The results indicate that removal rate of PFOA achieved by cell assembly operating at low current density (0.1 A/300 cm²=0.03 A/dm²) is unsatisfactory (Example 18; 20% of PFOA was removed from the water). Tenfold increase of the amperage (Example 19) led to enhanced removal rate, but still an appreciable percentage of the PFOA remained intact. But operation at low current density can yield high removal rates upon addition of salts of the invention. While addition of sodium chloride hardly influenced the removal rate of PFOA from the water (Example 20), a strong decontamination effect was achieved by both ferric chloride and ferrous bromide, i.e., salts composed of a reducible cation of a transition metal that can assume multiple oxidation states and an oxidizable anion (Examples 21-22). The supply of useful cation and anion to the water can be done by addition of two salts or even a single salt of the transition metal, as natural salinity of the treated water may account for effective chloride levels resulting in a decontamination effect of PFAS (Example 23).

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An electrochemical decontamination method of removing fluorinated organic compound(s) (FOC(s)) from an aqueous stream, comprising applying electric voltage across electrodes in contact with the FOC(s)-containing aqueous stream in the presence of at least one Mⁿ⁺ and at least one A^{k-}, wherein Mⁿ⁺ is a reducible cation of a transition metal that can assume multiple oxidation states and A^{k-} is an oxidizable anion.

2. The method according to claim 1, comprising adding to the FOC-containing aqueous stream a salt of the formula (Mⁿ⁺)ₐ(A^{k-})_{b} wherein Mⁿ⁺ is a cation of a transition metal selected from the group consisting of iron, nickel, manganese and copper.

3. The method according to claim 1, comprising adding to the FOC-containing aqueous stream one or more chloride salts of the formula MClₙ.

4. The method according to claim 3, wherein the salt is ferric chloride.

5. The method according to claim 1, wherein the removal of FOC includes FOC decomposition and fluoride production.

6. The method according to claim 5, comprising adding to the FOC-containing aqueous stream one or more (Mⁿ⁺)ₐ(A^{k-})_{b} salts at a concentration effective to maximize both FOC decomposition and fluoride production.

7. The method according to claim 6, wherein the effective concentration of the (Mⁿ⁺)ₐ(A^{k-})_{b} salt is determined from fluoride production versus [(Mⁿ⁺)ₐ(A^{k-})_{b}] relationship, wherein said relationship shows a maximum in the range from 1:3 to 1:1 of FOC:(Mⁿ⁺)ₐ(A^{k-})_{b}.

8. The method according to claim 1, wherein at least one electrode is an iron-based electrode or a copper-based electrode.

9. The method according to claim 8, comprising applying an electric voltage across a pair of bare stainless-steel electrodes or a pair of noble metal-coated stainless steel electrodes.

10. The method according to claim 9, comprising applying an electric voltage across a pair of palladium-coated stainless-steel electrodes.

11. The method according to claim 8, wherein the progress of FOC removal from the aqueous stream is monitored by pH control.

12. The method according to claim 1, carried out at current density in the range of 0.03 to 10.0 A/dm².

13. The method according to claim 12, wherein the current density is in the range of 0.03 to 2.0 A/dm².

14. The method according to claim 1, wherein the FOC comprises aromatically-bound fluorine.

15. The method according to claim 1, wherein the FOC(s) comprise one or more perfluoroalkyl compound(s) of the formula CₙF₂ₙ₊₁—R or R′—CₙF₂ₙ—R″ where n is in integer in the range from 3 to 15, and R, R′, R″ are functional groups devoid of carbon atoms or C—F bonds.

16. The method according to claim 15, wherein the perfluoroalkyl compound is selected from the group consisting of perfluorinated carboxylic acids and perfluorinated sulfonic acid.

17. The method according to claim 1, wherein the initial concentration of each FOC(s) in the aqueous stream is less than 10 ppb.

18. The method according to claim 1, comprising applying electric voltage across an electrode stack immersed in an aqueous stream contaminated by one or more compounds with the formulas CₙF₂ₙ₊₁—COOH) and CₙF₂ₙ₊₁—SO₃H, wherein n is independently an integer in the range from 3 to 15, each of said compounds is present at a concentration below 10 ppb, to pass a current at current density in the range from 0.03 to 2.0 A/dm², in the presence a cation of a transition metal selected from the group consisting of iron, nickel, manganese and copper, and an anion selected from chloride and bromide.

19. The method according to claim 18, wherein the electrode stack consists of a plurality of bare stainless-steel electrodes in the shape of plates, which are positioned in parallel in a batch container with spacings of less than 1 cm between the electrodes.
